(19) United States
(12) Patent Application Publication
(10) Pub. No.: US 2022/0395746 A1
(43) Pub. Date: Dec. 15, 2022

(54) SILICONE PUZZLE WITH BOARD/TRAY AND PUZZLE PIECES

(71) Applicants: Betty T. Ta, Newport Beach, CA (US); Alan Hong, Newport Beach, CA (US)

(72) Inventors: Betty T. Ta, Newport Beach, CA (US); Alan Hong, Newport Beach, CA (US)

(21) Appl. No.: 17/347,825

(22) Filed: Jun. 15, 2021

(51) Int. Cl. A63F 9/06

(52) U.S. Cl. CPC A63F 9/0666; A63F 2250/18

(57) ABSTRACT

A puzzle system includes a flexible plate having cavities of arbitrary shapes, a stiffener structure, and flexible puzzle pieces which are also of arbitrary shapes. The thickness of the puzzle pieces is equal to or greater than the depth of the cavities. The shape of at least one of the puzzle pieces substantially matches the shape of at least one of the cavities. The flexible plate and the flexible puzzle pieces may further include embossing, debossing, and/or imprints.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

The present invention relates to a puzzle system including a flexible plate with an embedded stiffener structure and flexible puzzle pieces. The flexible plate includes cavities of arbitrary shapes. The flexible puzzle pieces are also of arbitrary shapes and are removably insertable into the cavities.

### BACKGROUND

Conventional children's puzzles are made of wood and paper; which are not food safe and difficult to clean/sanitize (wooden puzzles are not water-friendly). Moreover, during the COVID pandemic, many schools did not allow students to play with puzzles to minimize the spread of viruses due to the fact that these wooden puzzles are difficult to clean. Therefore, there is a need for an educational puzzle made of a flexible material that is safe for children of all ages, as well as support individuals with special needs.

Silicone is one example of such material. The longevity of silicone and its resistance towards pressure and temperature makes it an ideal material which can withstand continuous stresses and pressures for a far longer period than rubber and without corroding or cracking in the process. Less contamination, long term financial savings and an all-around more hygienic structure all contribute to the advantages of using silicone.

However, silicone maybe too flexible and, by itself, does not provide the structural support necessary for the flexible plate to function properly. A stiffener structure has been embedded in the flexible plate to partially resist the flexing of the flexible plate.

Conventional puzzles on the market have surfaces that are 2-dimensional (flat) and only support visual learners. The present invention provides both 2-dimensional and 3-dimensional features to support both visual and kinesthetic learners. For instance, embossing and debossing provide 3-dimensional depth, which allows for an intricate look and feel to support learning through touch and sight.

The present invention is designed to support a combination of skills at the same time. 3-d and embossed/debossed features of the present invention help children explore new textures through sensory play. Children refine their fine motor and hand-eye coordination skills as they manipulate puzzle pieces to put the puzzle together. They develop the small muscles in their hand that allow them to grasp and move puzzle pieces with precision.

The ability to observe, recognize, and use visual information about forms, shapes, figures, and objects makes up our visual motor abilities. Visual motor skills include a coordination of visual information that is perceived and processed with motor skills, including fine motor, gross motor, and sensory motor. Children need practice with arranging and rearranging objects to help them build spatial awareness. The present invention allows children experiment with position (such as rotating, sliding, flipping). With practice and experience, they develop the ability to mentally manipulate the pieces. Persevering to solve challenging puzzles lend itself to better memory retention as well as a sense of accomplishment and pride in oneself. The present invention fosters foundational skills and learning in young children. Examples: kids may learn their alphabet, numbers, shapes, colors.

The present invention also fosters advanced skills for older kids. Examples: STEM (Science Technology Engineering Math)—focused puzzles such as periodic tables, body systems, planets, solar system, etc. The present invention also provides textured (embossed and debossed designs, graphics, texts) components to support multisensory learning. Textured and colorful puzzle pieces arouse interest, rivet attention, and make it possible to discover different textures and sights. Children with sensory processing disorder are able to explore different textures on the puzzle pieces and puzzle tray.

The present invention provides play therapy with meaningful sensory to encourage exploratory learning for children with autism. Kids and individuals with oral aversion issues can receive oral stimulation and input using textured puzzle pieces as teethers. The present invention includes an embossed Braille System on the flexible plate and/or the flexible puzzle pieces in which raised dots represent the letters and numbers to support touch reading and writing for the blind. The flexible plate and/or the flexible puzzle pieces maybe made of silicone and designed to have a matte finish to allow for wipeable/erasable writing surface when used with appropriate wet-erase markers and/or other appropriate water-soluble writing/drawing utensils. Tracings can be added to the surface of the flexible plate and/or the flexible puzzle pieces to refine pre-writing skills, and builds the foundation for drawing and writing letters and words.

Conventional puzzles in the market are not made for outdoor use and most cannot be used with water. The present invention can be made waterproof. It is also safe for outdoor play and use because silicone is highly resistant to oxygen, ozone, UV light, aging, weather, and extreme temperatures. It works in temperatures that range from −67° F. to +400° F., and intermittent to ±450° F.

Conventional puzzles in the market are not made to grow with the child. The present invention can be used from birth and beyond (infant, toddler, and kids). Flexible puzzle pieces made of food grade silicone can be used as baby teethers. For babies, the texture helps with sensory (learning through texture.) For toddlers, the present invention provides for fine motor, visual-motor, and spatial skills. It further fosters foundational skills such as print concepts, phonological awareness, phonics and word recognition, fluency, colors, numbers, alphabet, shapes, animals, other objects, etc. For kids, it provides educational features to be used for STEM Education. The flexible puzzle pieces maybe made from food-grade silicone for safe oral use. They can also include different textured surfaces (having many different protrusions) and can be used as baby teethers to soothe babies' gums. They can provide pain relief during teething, and oral stimulation (tongue, mouth, gums).

The 3-dimensional and textured features of the present invention support sensory integration therapy that aims to help kids with sensory processing issues (which some people may refer to as “sensory integration disorder”) by exposing them to sensory stimulation in a structured, repetitive way. The theory behind it is that over time, the brain will adapt and allow kids to process and react to sensations more efficiently.

The present invention may also have a lip which functions as a perimeter boundary to contain puzzle pieces and prevent the falling of puzzle pieces. It can also be made from Food Grade Silicone and Food Grade Interior Stainless Steel Frame(s)/Beam(s). The food-grade silicone may have a Shore A durometer of between about 45 and about 85. Silicone is free of harmful/toxic chemicals. It can be BPA Free, PVC Free, Lead Free, Cadmium Free, Mercury Free, Phthalate Free. Moreover, Silicone is heat and water resistant. Silicone has inherent microbial effect. Unlike conventional puzzles, the present invention is durable and is easy to clean and sanitize (this is extremely important to limit the spread of virus and bacteria). The flexible puzzle pieces are removably insertable into the cavities. They may further include peg handles.

### SUMMARY

In one aspect, a puzzle system is disclosed, wherein the system comprises a flexible plate comprising a plurality of cavities disposed on at least one side of the flexible plate, wherein the plurality of cavities have one or more arbitrary cavity shapes, a stiffener structure embedded inside the flexible plate, wherein the stiffener structure is operable to partially resist the flexing of the flexible plate, and a plurality of flexible puzzle pieces, wherein the plurality of flexible puzzle pieces have one or more arbitrary piece shapes, wherein a thickness of the plurality of flexible puzzle pieces is equal to or greater than a depth of the plurality of cavities, wherein at least one of the one or more arbitrary piece shapes substantially matches a shape of at least one of the one or more arbitrary cavity shapes, and wherein at least one of the plurality of flexible puzzle pieces is removably insertable in at least one of the plurality of cavities.

Preferably, a shape of the flexible plate is an arbitrary shape.

Preferably, the arbitrary shape is one of a square shape, a rectangular shape, a circular shape, an elliptical shape, a flower shape, a vehicle shape, a heart shape, a house shape, an animal shape, and a country shape.

Preferably, the flexible plate comprises a lip around a perimeter of the flexible plate operative to maintain the plurality of flexible puzzle pieces within the flexible plate.

Preferably, the flexible plate comprises at least one of an embossing, a debossing, and an imprint.

Preferably, the at least one of an embossing, a debossing, and an imprint comprises at least one of a text and an image.

Preferably, the at least one of a text and an image comprises at least one of letters of alphabet, foreign language special characters, numbers, geometric shapes, pictures of persons, pictures of animals, colors, and Braille system.

Preferably, the cavity shapes comprise at least one of shapes of letters of alphabet, shapes of foreign language special characters, shapes of numbers, geometric shapes, shapes of persons, and shapes of animals.

Preferably, the flexible plate comprises silicone.

Preferably, at least one of the plurality of flexible puzzle pieces comprises at least one of an embossing, a debossing, and an imprint.

Preferably, the at least one of an embossing, a debossing, and an imprint comprises at least one of a text and an image.

Preferably, the at least one of a text and an image comprises at least one of letters of alphabet, foreign language special characters, numbers, geometric shapes, pictures of persons, pictures of animals, colors, and Braille system.

Preferably, the piece shapes comprise at least one of shapes of letters of alphabet, shapes of foreign language special characters, shapes of numbers, geometric shapes, shapes of persons, and shapes of animals.

Preferably, the plurality of flexible puzzle pieces comprises silicone.

Preferably, a shape of the flexible plate is a rectangular shape and wherein the stiffener structure comprises wire disposed at least along one of at least one of a portion and an entirety of a perimeter of the flexible plate, at least one diagonal axis of the rectangular shape, at least one horizontal axis of the rectangular shape, and at least one vertical axis of the rectangular shape.

Preferably, the wire comprises stainless steel.

In another aspect, a plurality of flexible puzzle pieces for use with a flexible plate are disclosed, wherein the flexible plate comprises a plurality of cavities disposed on at least one side of the flexible plate, wherein the plurality of cavities have one or more arbitrary cavity shapes, wherein the plurality of flexible puzzle pieces have one or more arbitrary piece shapes, wherein a thickness of the plurality of flexible puzzle pieces is equal to or greater than a depth of the plurality of cavities, wherein at least one of the one or more arbitrary piece shapes substantially matches a shape of at least one of the one or more arbitrary cavity shapes, and wherein at least one of the plurality of flexible puzzle pieces is removably insertable in at least one of the plurality of cavities.

Preferably, at least one of the plurality of flexible puzzle pieces comprises at least one of an embossing, a debossing, and an imprint.

Preferably, the piece shapes comprise at least one of shapes of letters of alphabet, shapes of foreign language special characters, shapes of numbers, geometric shapes, shapes of persons, and shapes of animals.

In another aspect, a method of engaging a child is disclosed, wherein the method comprises providing a flexible plate comprising a plurality of cavities disposed on at least one side of the flexible plate, wherein the plurality of cavities have one or more arbitrary cavity shapes, providing a stiffener structure embedded inside the flexible plate, wherein the stiffener structure is operable to partially resist the flexing of the flexible plate, and providing a plurality of flexible puzzle pieces, wherein the plurality of flexible puzzle pieces have one or more arbitrary piece shapes, wherein a thickness of the plurality of flexible puzzle pieces is equal to or greater than a depth of the plurality of cavities, wherein at least one of the one or more arbitrary piece shapes substantially matches a shape of at least one of the one or more arbitrary cavity shapes, and wherein at least one of the plurality of flexible puzzle pieces is removably insertable in at least one of the plurality of cavities.

### DESCRIPTION OF THE DRAWINGS

FIG. 1 shows a perspective view of a puzzle system according to a preferred embodiment.

FIG. 2 shows an exploded view of a puzzle system according to a preferred embodiment. The puzzle system includes a flexible plate having a plurality of cavities and a plurality of flexible puzzle pieces which are removably insertable into the cavities. The cavities have the shapes of numbers. The flexible plate further includes embossed words, zero through nine, and the flexible puzzle pieces have the shapes of numbers.

FIG. 3 shows an exploded view of a puzzle system according to a preferred embodiment. The puzzle system includes a flexible plate having a plurality of cavities and a plurality of flexible puzzle pieces which are removably insertable into the cavities. The cavities have the shapes of numbers. The flexible plate further includes embossed words, zero through nine, and the flexible puzzle pieces have the shapes of numbers. The flexible puzzle pieces 1 through 9, each have embossing according to the number they represent. The flexible puzzle piece corresponding to the number 0 has no embossing.

FIG. 4 shows an exploded view of a puzzle system according to a preferred embodiment. The puzzle system includes a flexible plate having a plurality of cavities and a plurality of flexible puzzle pieces which are removably insertable into the cavities. The cavities have the shapes of numbers. The flexible plate further includes embossed words, zero through nine, and the flexible puzzle pieces have the shapes of numbers. The flexible puzzle pieces 0 through 9, each have embossing and debossing in the shape of circles, strips, ellipses, triangles, squares, rectangles, pyramids, curves, and hexagons. The flexible puzzle pieces further include pegs which can be used to insert and extract the puzzle pieces from the cavities.

FIG. 5 shows an exploded view of a puzzle system according to a preferred embodiment. The puzzle system includes a flexible plate having a plurality of cavities and a plurality of flexible puzzle pieces which are removably insertable into the cavities. The cavities have the shapes of the letter of alphabet. The flexible puzzle pieces also have the shapes of the letter of alphabet. The flexible puzzle pieces further include embossing according to the Braille system and letter tracing.

FIG. 6A shows a cutaway cross-sectional view of a flexible puzzle piece according to a preferred embodiment. The flexible puzzle piece has the shape of the number 7 and further includes embossing and debossing that make up the geometric shape of a hexagon.

FIG. 6B shows a cutaway cross-sectional view of a flexible puzzle piece according to a preferred embodiment. The flexible puzzle piece has the shape of the letter H and further includes embossing of the letter H according to the Braille system and letter tracing.

FIG. 7 shows a cutaway cross-sectional view of a flexible plate according to a preferred embodiment. The flexible plate has a rectangular shape and has a plurality of cavities which have the shapes of a fish. The flexible plate further includes imprints of the Chinese language special characters. A stiffener structure is embedded inside the flexible plate shown in dashed lines. The stiffener structure is a stainless-steel wire that runs along the entirety of the perimeter of the flexible plate and its horizontal and vertical axes, so as to partially resist the flexing of the flexile plate. The flexible plate further includes a lip around the perimeter of the flexible plate which operates to maintain the plurality of flexible puzzle pieces (not shown) within the flexible plate.

FIG. 8 shows a top view of a stiffener structure according to a preferred embodiment. The stiffener structure is a wire and has a rectangular shape with rounded corners and four segments at the four corners of the stiffener structure.

FIG. 9 shows a top view of a stiffener structure according to a preferred embodiment. The stiffener structure is a wire and has a rectangular shape with rounded corners, a horizontal section, and a vertical section along the horizontal and vertical axes of the stiffener structure.

FIG. 10 shows a top view of a stiffener structure according to a preferred embodiment. The stiffener structure is a wire and has a rectangular shape with rounded corners and a horizontal section along the horizontal axis of the stiffener structure.

FIG. 11 shows a top view of a stiffener structure according to a preferred embodiment. The stiffener structure is a wire and has a rectangular shape with rounded corners and a vertical section along the vertical axis of the stiffener structure.

FIG. 12 shows a top view of a stiffener structure according to a preferred embodiment. The stiffener structure is a wire and has a rectangular shape with rounded corners, a first diagonal section, and a second diagonal section along the diagonal axes of the stiffener structure.

FIG. 13 shows a side view of a puzzle system according to a preferred embodiment. The thickness of the flexible puzzle pieces is greater than the depth of the cavities in the flexible plate allowing easy insertion and extraction of the flexible puzzle pieces in and out of the flexible plate.

### DETAILED DESCRIPTION OF THE PRESENTLY PREFERRED EMBODIMENTS

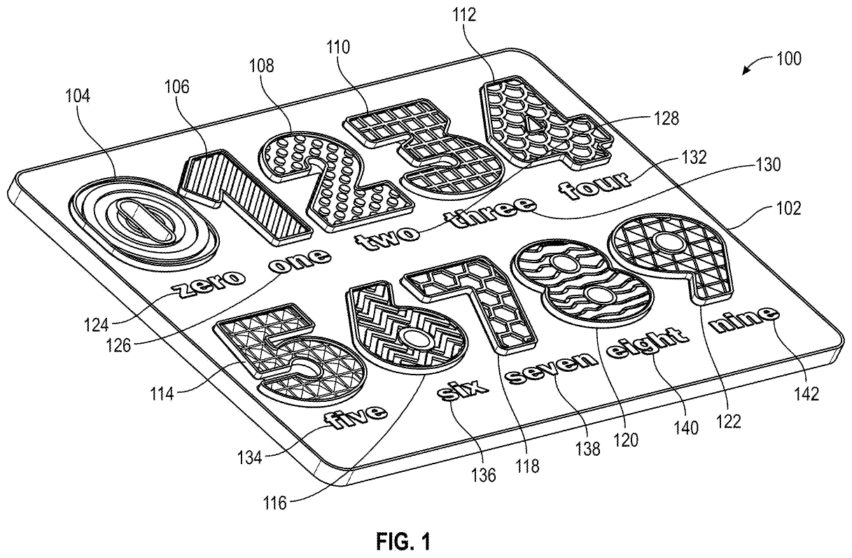

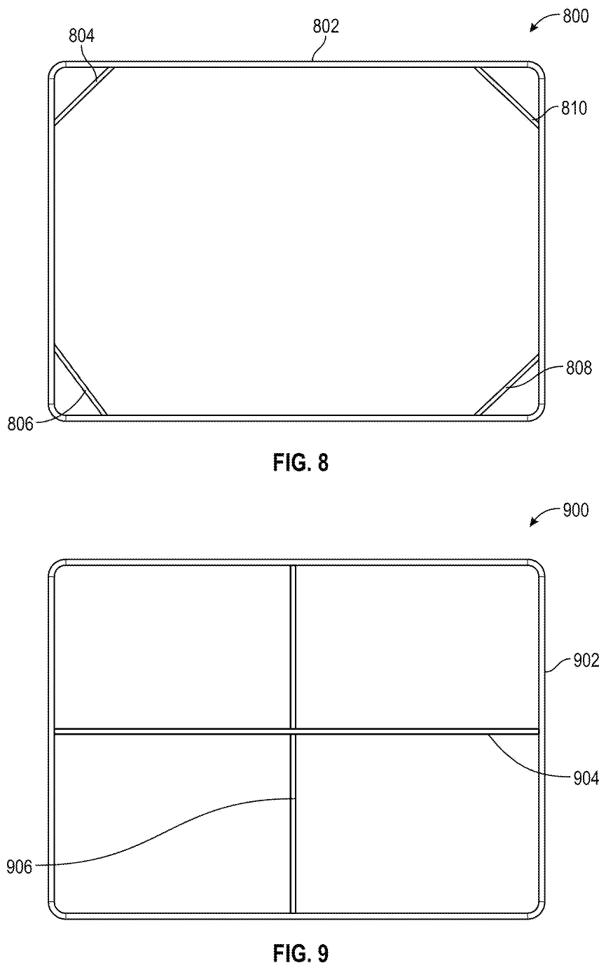

FIG. 1 depicts a perspective view of a puzzle system 100 comprising a flexible plate 102, a stiffener structure (not shown) such as those depicted in FIGS. 8 through 12, and a plurality of flexible puzzle pieces 104, 106, 108, 110, 112, 114, 116, 118, 120, and 122. The puzzle system can be used to engage a child to develop and/or improve his/her motor skills. As described above, conventional puzzle systems are two dimensional and are made of hard materials. The present puzzle system 100 is three dimensional and made from flexible material. For instance, the flexible plate 102 and the flexible puzzle pieces 104, 106, 108, 110, 112, 114, 116, 118, 120, and 122 can be made from polymers such as silicone or polysiloxane.

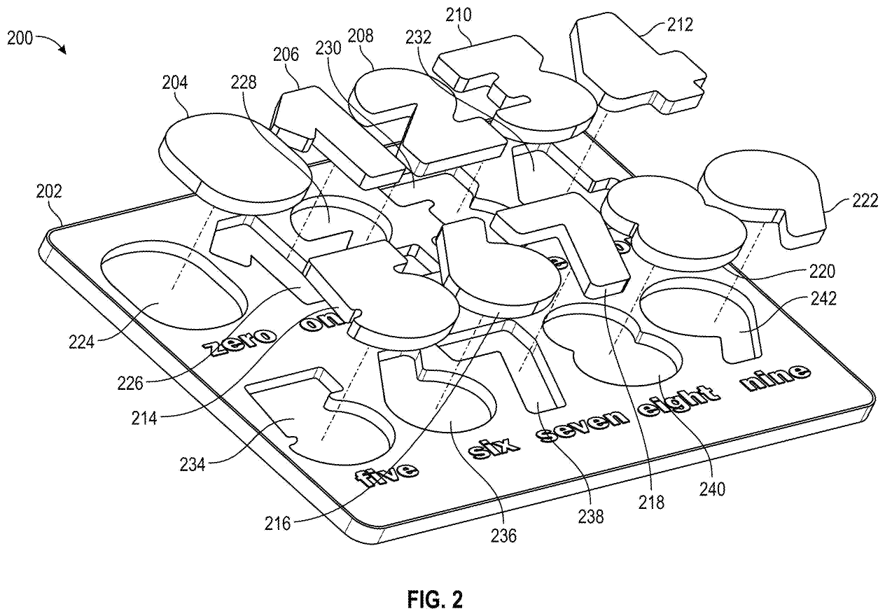

The flexible plate 102 comprises a plurality of cavities (not shown) such as those depicted in FIGS. 2 through 5. The cavities have one or more arbitrary cavity shapes and can be on either side of the flexible plate 102. Moreover, in a preferred embodiment, the flexible plate 102 has only one cavity of arbitrary shape. The flexible puzzle pieces 104, 106, 108, 110, 112, 114, 116, 118, 120, and 122 also have one or more arbitrary piece shapes. In a preferred embodiment, all the cavities have only one shape, for instance the shape of a fish, and all the flexible puzzle pieces 104, 106, 108, 110, 112, 114, 116, 118, 120, and 122 have only one shape, i.e., the shape of a fish.

The thickness of the plurality of flexible puzzle pieces 104, 106, 108, 110, 112, 114, 116, 118, 120, and 122 is equal to or greater than a depth of the plurality of cavities. Moreover, at least one of the one or more arbitrary piece shapes of the flexible puzzle pieces 104, 106, 108, 110, 112, 114, 116, 118, 120, and 122 substantially matches a shape of at least one of the one or more arbitrary cavity shapes of the plurality of cavities of the flexible plate 102. Furthermore, at least one of the plurality of flexible puzzle pieces 104, 106, 108, 110, 112, 114, 116, 118, 120, and 122 is removably insertable in at least one of the plurality of cavities. In a preferred embodiment, the thickness of the plurality of flexible puzzle pieces 104, 106, 108, 110, 112, 114, 116, 118, 120, and 122 is equal to the depth of the plurality of cavities but each of the flexible puzzle pieces 104, 106, 108, 110, 112, 114, 116, 118, 120, and 122 have a handle (peg) to allow the child to insert and extract the flexible puzzle piece into and out of the cavities.

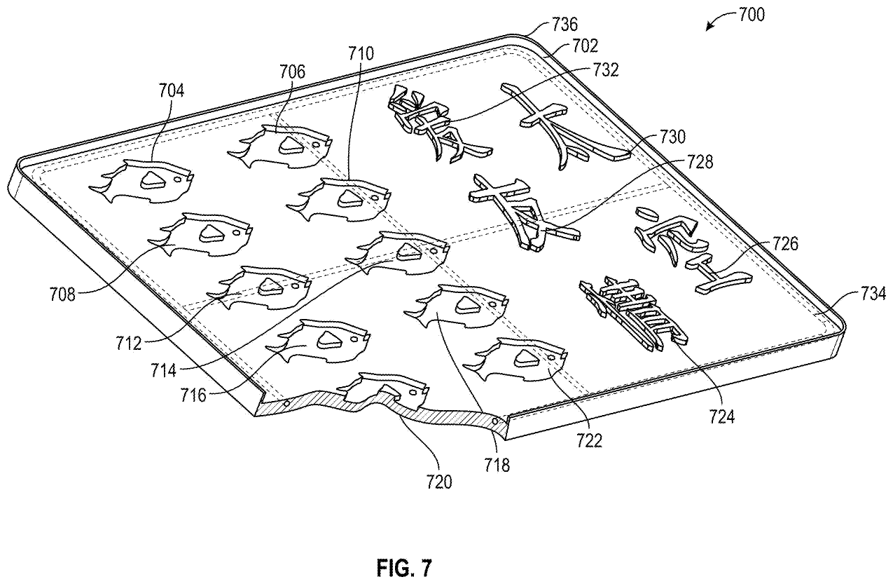

The shape of the flexible plate 102 is arbitrary. In this preferred embodiment, the flexible plate 102 has a rectangular shape, however, other shapes are also contemplated. For instance, the flexible plate 102 can have the shapes of a square shape, a rectangular shape, a circular shape, an elliptical shape, a flower shape, a vehicle shape, a heart shape, a house shape, an animal shape, or a country shape. In a preferred embodiment, the flexible plate 102 comprises a lip (not shown) such as that depicted in FIG. 7, around a perimeter of the flexible plate 102 which operates to maintain the plurality of flexible puzzle pieces 104, 106, 108, 110, 112, 114, 116, 118, 120, and 122 within the flexible plate 102.

The flexible plate 102 can have at least one of an embossing, a debossing, and an imprint which may be a text, an image, or a combination of text and image. As such, the embossings, debossings, and texts can be letters of alphabet, foreign language special characters, numbers, geometric shapes, pictures of persons, pictures of animals, colors, the Braille system, or a combination thereof.

In this preferred embodiment, the flexible plate 102 includes a plurality of embossings 124, 126, 128, 130, 132, 134, 136, 138, 140, and 142. These embossings 124, 126, 128, 130, 132, 134, 136, 138, 140, and 142 are the English letters that make of the words for zero, one, two, three, four, five, six, seven, eight, and nine to correspond to the shape of the cavities and the flexible puzzle pieces 104, 106, 108, 110, 112, 114, 116, 118, 120, and 122. In an alternative embodiment, the plurality of embossings 124, 126, 128, 130, 132, 134, 136, 138, 140, and 142 are debossings. In yet another embodiment, the plurality of embossings 124, 126, 128, 130, 132, 134, 136, 138, 140, and 142 are the Chinese characters that make up the words for zero, one, two, three, four, five, six, seven, eight, and nine to correspond to the shape of the cavities and the flexible puzzle pieces 104, 106, 108, 110, 112, 114, 116, 118, 120, and 122.

FIG. 2 depicts an exploded view of a puzzle system 200 comprising a flexible plate 202, a stiffener structure (not shown) such as those depicted in FIGS. 8 through 12, and a plurality of flexible puzzle pieces 204, 206, 208, 210, 212, 214, 216, 218, 220, and 222. The flexible plate 202 comprises a plurality of cavities 224, 226, 228, 230, 232, 234, 236, 238, 240, and 242 which have the shapes of numbers 0 through 9. The flexible puzzle pieces 204, 206, 208, 210, 212, 214, 216, 218, 220, and 222 are readily inserted and extracted into and out of the cavities 224, 226, 228, 230, 232, 234, 236, 238, 240, and 242. In this preferred embodiment, the thickness of the flexible puzzle pieces is greater than the depth of the cavities 224, 226, 228, 230, 232, 234, 236, 238, 240, and 242. The shape of the cavities 224, 226, 228, 230, 232, 234, 236, 238, 240, and 242 may comprise shapes of letters of alphabet, shapes of foreign language special characters, shapes of numbers, geometric shapes, shapes of persons, shapes of animals, or a combination thereof.

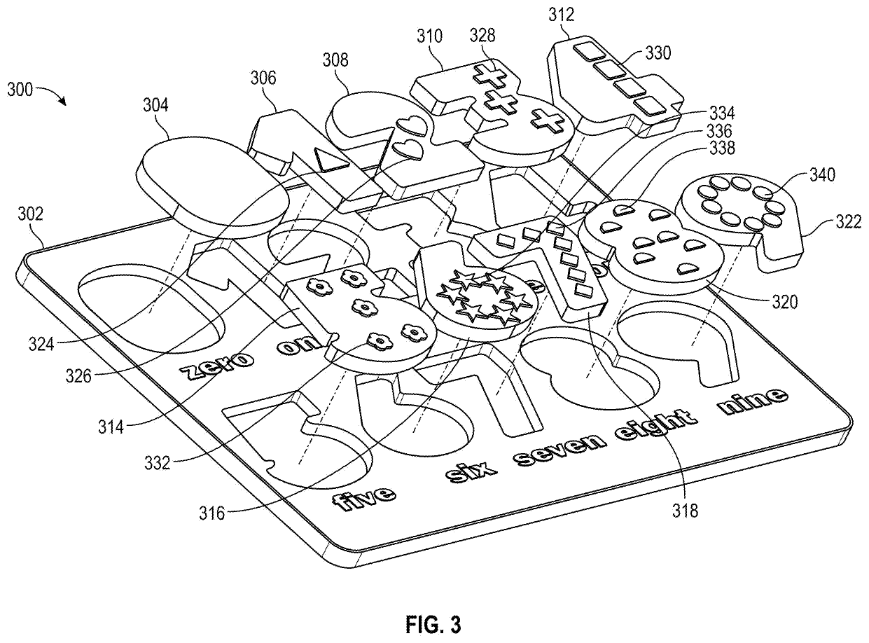

FIG. 3 shows an exploded view of a puzzle system 300 comprising a flexible plate 302, a stiffener structure (not shown) such as those depicted in FIGS. 8 through 12, and a plurality of flexible puzzle pieces 304, 306, 308, 310, 312, 314, 316, 318, 320, and 322 which are removably insertable into the cavities of the flexible plate 302. The cavities and the flexible puzzle pieces 304, 306, 308, 310, 312, 314, 316, 318, 320, and 322 have the shapes of numbers 0 through 9. The shapes of the flexible puzzle pieces 304, 306, 308, 310, 312, 314, 316, 318, 320, and 322 substantially match the shapes of the cavities. In this preferred embodiment, the flexible plate 302 further includes embossed words, zero through nine and the flexible puzzle pieces 304, 306, 308, 310, 312, 314, 316, 318, 320, and 322 have embossed features.

In particular flexible puzzle piece 304 has no embossed feature promoting the notion of the number 0. The flexible puzzle piece 306 has a triangular feature 324 embossed on top of its surface representing the notion of the number 1. Similarly, the flexible puzzle piece 308 has two heart shaped features 326 embossed on its surface representing the notion of the number 2. The flexible puzzle piece 310 has three cross shaped features 328 embossed on its surface representing the notion of the number 3. The flexible puzzle piece 312 has four square shaped features 330 embossed on its surface representing the notion of the number 4. The flexible puzzle piece 314 has five flower shaped features 332 embossed on its surface representing the notion of the number 5. The flexible puzzle piece 316 has six star shaped features 334 embossed on its surface representing the notion of the number 6. The flexible puzzle piece 318 has seven diamond shaped features 336 embossed on its surface representing the notion of the number 7. The flexible puzzle piece 320 has eight half-circle shaped features 338 embossed on its surface representing the notion of the number 8. And the flexible puzzle piece 322 has nine circle shaped features 340 embossed on its surface representing the notion of the number 9.

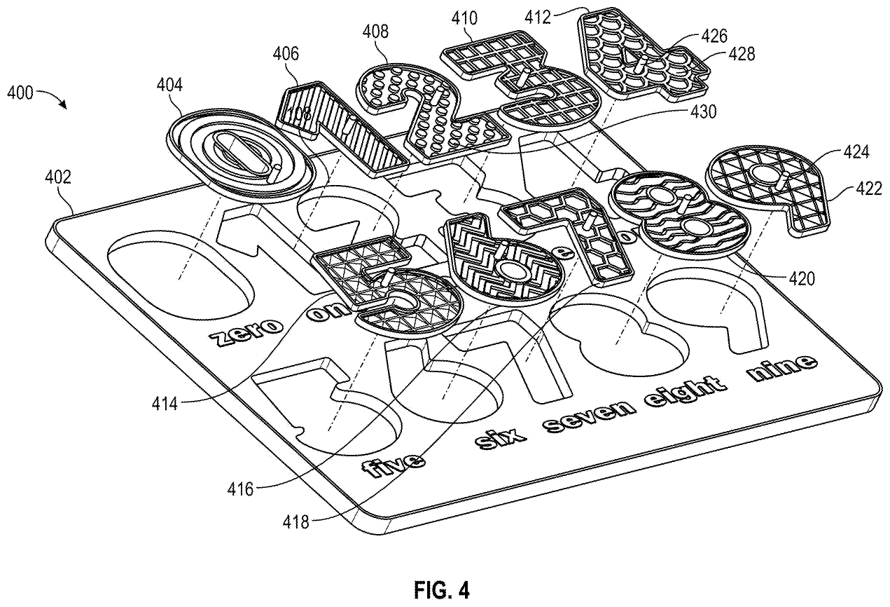

FIG. 4 shows an exploded view of a puzzle system 400 comprising a flexible plate 402, a stiffener structure (not shown) such as those depicted in FIGS. 8 through 12, and a plurality of flexible puzzle pieces 404, 406, 408, 410, 412, 414, 416, 418, 420, and 422 which are removably insertable into the cavities of the flexible plate 402. The cavities and the flexible puzzle pieces 404, 406, 408, 410, 412, 414, 416, 418, 420, and 422 have the shapes of numbers 0 through 9. The shapes of the flexible puzzle pieces 404, 406, 408, 410, 412, 414, 416, 418, 420, and 422 substantially match the shapes of the cavities. In this preferred embodiment, the flexible plate 402 further includes embossed words, zero through nine and the flexible puzzle pieces 404, 406, 408, 410, 412, 414, 416, 418, 420, and 422 have embossed and debossed features in the shape of circles, strips, ellipses, triangles, squares, rectangles, pyramids, curves, and hexagons.

For instance, the flexible puzzle piece 408, representing the number 2, has embossing features 430 and the flexible puzzle piece 412, representing the number 4 has debossing features 428. Moreover, in this preferred embodiment, the thickness of the flexible puzzle pieces 404, 406, 408, 410, 412, 414, 416, 418, 420, and 422 is equal to the depth of the cavities of the flexible plate 402. As such, each of the flexible puzzle pieces has a handle (peg) to allow the child to insert and extract the flexible puzzle piece into and out of the cavities. For instance, the flexible puzzle piece 412, representing the number 4 has a peg 426 and the flexible puzzle piece 422, representing the number 9, has a peg 424.

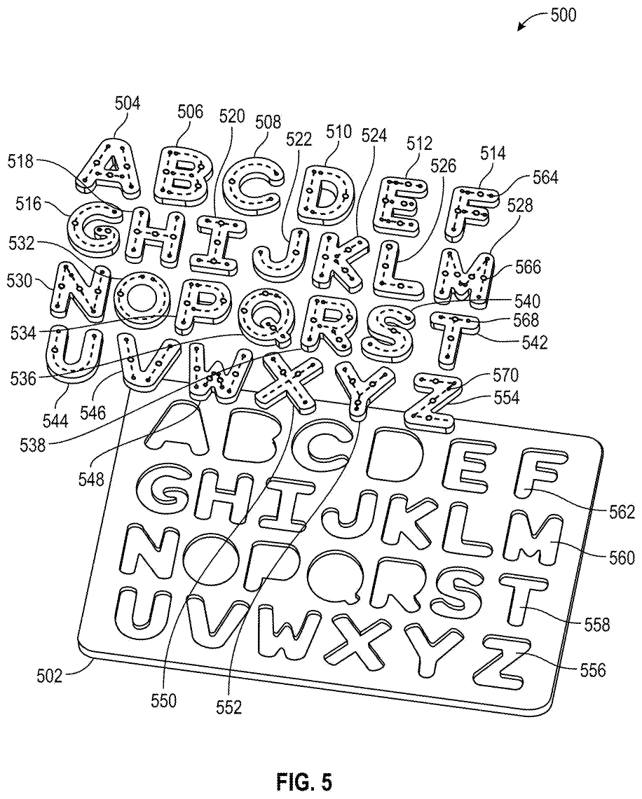

FIG. 5 depicts an exploded view of a puzzle system 500 comprising a flexible plate 502, a stiffener structure (not shown) such as those depicted in FIGS. 8 through 12, and a plurality of flexible puzzle pieces 504, 506, 508, 510, 512, 514, 516, 518, 520, 522, 524, 526, 528, 530, 532, 534, 536, 538, 540, 542, 544, 546, 548, 550, 552, and 554 which are removably insertable into the cavities of the flexible plate 502. The cavities and the flexible puzzle pieces 504, 506, 508, 510, 512, 514, 516, 518, 520, 522, 524, 526, 528, 530, 532, 534, 536, 538, 540, 542, 544, 546, 548, 550, 552, and 554 have the shapes of the English alphabets A through Z. The shapes of the flexible puzzle pieces 504, 506, 508, 510, 512, 514, 516, 518, 520, 522, 524, 526, 528, 530, 532, 534, 536, 538, 540, 542, 544, 546, 548, 550, 552, and 554 substantially match the shapes of the cavities. In this preferred embodiment, the flexible puzzle pieces 504, 506, 508, 510, 512, 514, 516, 518, 520, 522, 524, 526, 528, 530, 532, 534, 536, 538, 540, 542, 544, 546, 548, 550, 552, and 554 have embossed features in the shape of the letters they represent. In another embodiment, these embossings can include the Braille system and letter tracing.

For instance, the flexible puzzle piece 514, representing the letter F, has embossing features 564, the flexible puzzle piece 528, representing the letter M, has embossing features 566, the flexible puzzle piece 542, representing the letter T, has embossing features 568, and the flexible puzzle piece 554, representing the letter Z, has embossing features 570. The flexible puzzle pieces 514, 528, 542, and 554 are removably insertable into the cavities 562, 560, 558, and 556, respectively.

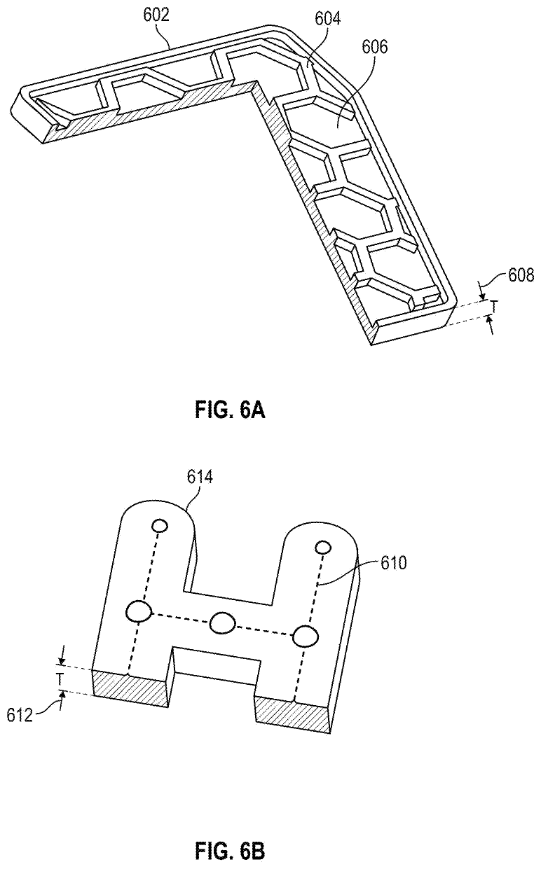

FIGS. 6A and 6B depict two embodiments of flexible puzzle pieces for use with a flexible plate such as the flexible plates 102, 202, 302, 402, or 502, wherein the flexible plate comprises a plurality of cavities disposed on at least one side of the flexible plate, wherein the plurality of cavities have one or more arbitrary cavity shapes, wherein the plurality of flexible puzzle pieces have one or more arbitrary piece shapes, wherein a thickness of the plurality of flexible puzzle pieces is equal to or greater than a depth of the plurality of cavities, wherein at least one of the one or more arbitrary piece shapes substantially matches a shape of at least one of the one or more arbitrary cavity shapes, and wherein at least one of the plurality of flexible puzzle pieces is removably insertable in at least one of the plurality of cavities. The piece shapes maybe the shape of at least one of shapes of letters of alphabet, shapes of foreign language special characters, shapes of numbers, geometric shapes, shapes of persons, shapes of animals or a combination thereof.

For instance, FIG. 6A depicts a cutaway cross-sectional view of a flexible puzzle piece 602 according to a preferred embodiment. The flexible puzzle piece 602 has the shape of the number 7 and further includes embossing 604 and debossing 606 that make up the geometric shape of a hexagon. The flexible puzzle piece 602 has a thickness T at 608. In one embodiment, the thickness T at 608 is greater than a depth of the plurality of cavities t at 1308 (see FIG. 13). FIG. 6B depicts a cutaway cross-sectional view of a flexible puzzle piece 614 according to a preferred embodiment. The flexible puzzle piece 614 has the shape of the letter H and further includes embossing 610 of the letter H according to the Braille system. The flexible puzzle piece 614 has a thickness T at 612. In one embodiment, the thickness T at 612 is equal to a depth of the plurality of cavities t at 1308 (see FIG. 13). A handle (peg) (not shown) would be included to allow the child to insert and extract the flexible puzzle piece 614 into and out of the cavities.

FIG. 7 shows a cutaway cross-sectional view of a flexible plate 702 comprising and a stiffener structure (shown in dashed lines) 734 such as the stiffener structure depicted in FIG. 9. The flexible plate 702 comprises a plurality of cavities 704, 706, 708, 710, 712, 714, 716, 718, 722, and 724 which have the shapes of a fish. Although in this embodiment, the cavities 704, 706, 708, 710, 712, 714, 716, 718, and 722 are all in the same horizontal direction, they can be of different orientation. The flexible plate 702 further includes imprints of the Chinese language special characters 724, 726, 728, 730, and 732. The stiffener structure 734 is embedded inside the flexible plate 702 shown in dashed lines. In this preferred embodiment, the flexible plate 702 is 11.5 inches long, 8.5 inches wide, and 0.5 inch thick. The thickness T of the puzzle pieces (not shown) is 0.4 inches and the depth of the cavities t (not shown) is 0.4 inches. The stiffener structure 734 is a stainless-steel wire that runs along the entirety of the perimeter of the flexible plate 702 and its horizontal and vertical axes, so as to partially resist the flexing of the flexile plate 702. In an alternative embodiment, the stiffener structure 702 is made from hard plastic which has a greater elastic and/or flexural modulus than that of the flexible plate 702. Other materials such as wood or ceramic maybe used to construct the stiffener structure 734. As discussed above, the stiffener structure 734 partially resists the flexing of the flexible plate 702. The flexible plate 702 further includes a lip 736 around the perimeter of the flexible plate 702. The lip 736 operates to maintain the plurality of flexible puzzle pieces (not shown) within the flexible plate 702. In one preferred embodiment, the lip 736 has a height of 0.5 inch.

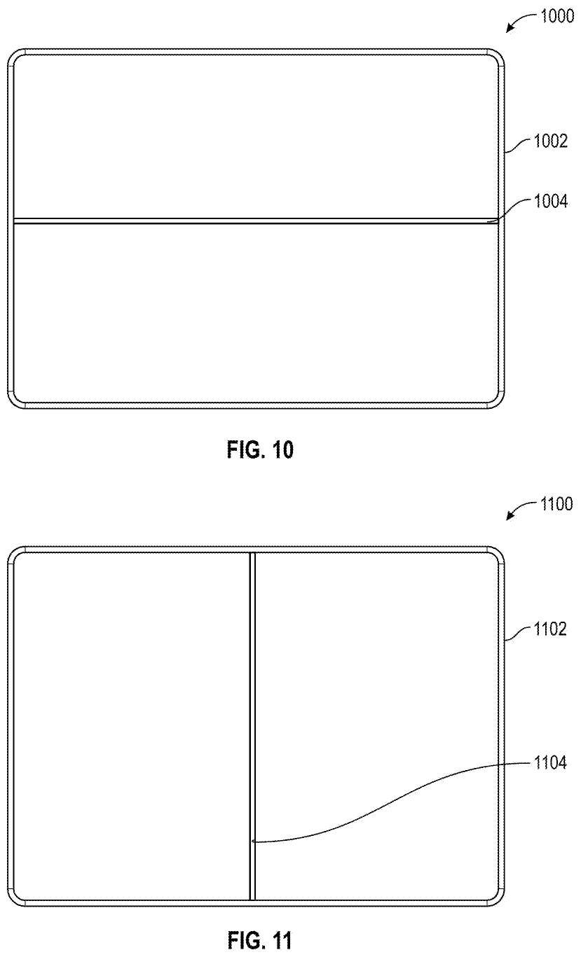

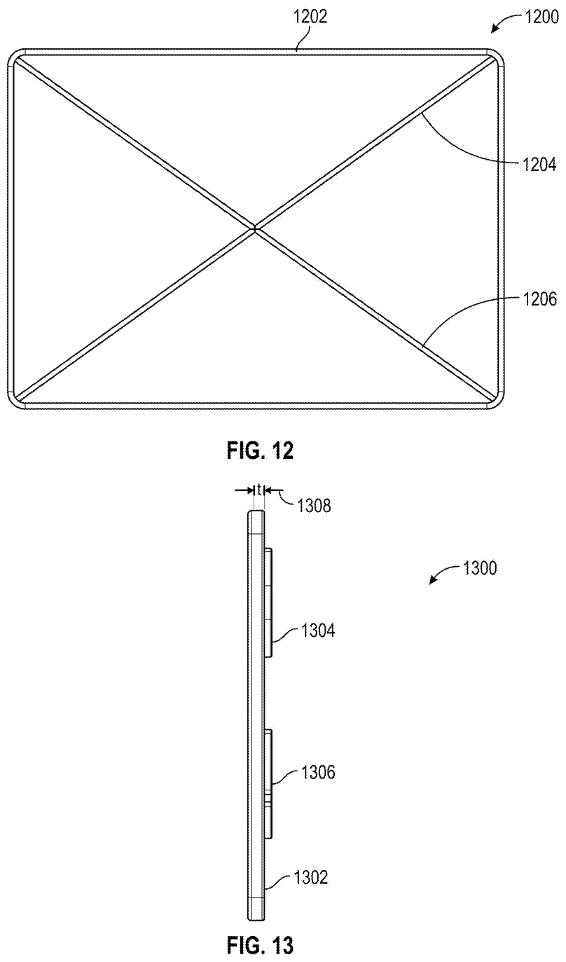

FIGS. 8 through 12 depict top views of several different stiffener structures that can be embedded inside the corresponding flexible plate to partially resist the flexing of the flexible plate. In particular, FIG. 8 depicts a top view of a stiffener structure 800 according to a preferred embodiment. The stiffener structure 800 is a wire, having a circular cross section of, for instance, 0.125 inches, and has a rectangular shape 802 with rounded corners and four segments, 804, 806, 808, and 810 at the four corners of the stiffener structure 800. FIG. 9 depicts a top view of a stiffener structure 900 according to a preferred embodiment. The stiffener structure 900 is a wire and has a rectangular shape 902 with rounded corners, a horizontal section 904, and a vertical section 906 along the horizontal and vertical axes of the stiffener structure 900. FIG. 10 depicts a top view of a stiffener structure 1000 according to a preferred embodiment. The stiffener structure 1000 is a wire and has a rectangular shape 1002 with rounded corners and a horizontal section 1004 along the horizontal axis of the stiffener structure 1000. FIG. 11 shows a top view of a stiffener structure 1100 according to a preferred embodiment. The stiffener structure 1100 is a wire and has a rectangular shape 1102 with rounded corners and a vertical section 1104 along the vertical axis of the stiffener structure 1100. FIG. 12 shows a top view of a stiffener structure 1200 according to a preferred embodiment. The stiffener structure 1200 is a wire and has a rectangular shape 1202 with rounded corners, a first diagonal section 1204, and a second diagonal section 1206 along the diagonal axes of the stiffener structure 1200.

FIG. 13 depicts a side view of a puzzle system 1300 comprising a flexible plate 1302, a stiffener structure (not shown) such as those depicted in FIGS. 8 through 12, and a plurality of flexible puzzle pieces such as flexible puzzle piece 1304 and flexible puzzle piece 1306. The flexible puzzle pieces are removably insertable into the cavities of the flexible plate 1302. The cavities and the flexible puzzle pieces have arbitrary shapes. The shapes of the flexible puzzle pieces substantially match the shapes of the cavities. The thickness of the flexible puzzle pieces, such as the flexible puzzle piece 1304 and the flexible puzzle piece 1306 is greater than the depth t at 1308 of the cavities in the flexible plate 1302 allowing easy insertion and extraction of the flexible puzzle pieces in and out of the flexible plate 1302.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

1. A puzzle system, comprising:
(a) a flexible plate comprising a plurality of cavities disposed on at least one side of the flexible plate, wherein the plurality of cavities have one or more arbitrary cavity shapes;
(b) a wire embedded inside the flexible plate and disposed along a perimeter of the flexible plate, wherein the wire is operable to partially resist the flexing of the flexible plate; and
(c) a plurality of flexible puzzle pieces, wherein the plurality of flexible puzzle pieces have one or more arbitrary piece shapes;
wherein a thickness of the plurality of flexible puzzle pieces is equal to or greater than a depth of the plurality of cavities, wherein at least one of the one or more arbitrary piece shapes substantially matches a shape of at least one of the one or more arbitrary cavity shapes, and wherein at least one of the plurality of flexible puzzle pieces is removably insertable in at least one of the plurality of cavities.

2. The system of claim 1, wherein a shape of the flexible plate is an arbitrary shape.

3. The system of claim 2, wherein the arbitrary shape is one of a square shape, a rectangular shape, a circular shape, an elliptical shape, a flower shape, a vehicle shape, a heart shape, a house shape, an animal shape, and a country shape.

4. The system of claim 1, wherein the flexible plate comprises a lip around a perimeter of the flexible plate operative to maintain the plurality of flexible puzzle pieces within the flexible plate.

5. The system of claim 1, wherein the flexible plate comprises at least one of an embossing, a debossing, and an imprint.

6. The system of claim 5, wherein the at least one of an embossing, a debossing, and an imprint comprises at least one of a text and an image.

7. The system of claim 6, wherein the at least one of a text and an image comprises at least one of:
(i) letters of alphabet;
(ii) foreign language special characters;
(iii) numbers;
(iv) geometric shapes;
(v) pictures of persons;
(vi) pictures of animals;
(vii) colors; and
(viii) Braille system.

8. The system of claim 1, wherein the cavity shapes comprise at least one of:
(i) shapes of letters of alphabet;
(ii) shapes of foreign language special characters;
(iii) shapes of numbers;
(iv) geometric shapes;
(v) shapes of persons; and
(vi) shapes of animals.

9. The system of claim 1, wherein the flexible plate comprises silicone.

10. The system of claim 1, wherein at least one of the plurality of flexible puzzle pieces comprises at least one of an embossing, a debossing, and an imprint.

11. The system of claim 10, wherein the at least one of an embossing, a debossing, and an imprint comprises at least one of a text and an image.

12. The system of claim 11, wherein the at least one of a text and an image comprises at least one of:
(i) letters of alphabet;
(ii) foreign language special characters;
(iii) numbers;
(iv) geometric shapes;
(v) pictures of persons;
(vi) pictures of animals;
(vii) colors; and
(viii) Braille system.

13. The system of claim 1, wherein the piece shapes comprise at least one of:
(i) shapes of letters of alphabet;
(ii) shapes of foreign language special characters;
(iii) shapes of numbers;
(iv) geometric shapes;
(v) shapes of persons; and
(vi) shapes of animals.

14. The system of claim 1, wherein the plurality of flexible puzzle pieces comprises silicone.

15. The system of claim 1, wherein a shape of the flexible plate is a rectangular-shape and wherein the wire comprises four segments disposed along four sides of the flexible plate and wherein the wire further comprises at least one of:
(i) a fifth segment along a first diagonal axis of the flexible plate;
(ii) a sixth segment along a second diagonal axis of the flexible plate;
(iii) a seventh segment along a horizontal axis of the flexible plate; and
(iv) an eighth segment along a vertical axis of the flexible plate.

16. The system of claim 15, wherein the wire comprises stainless steel.

17. A plurality of flexible puzzle pieces made from food grade silicone for use with a flexible plate, wherein the flexible plate comprises a plurality of cavities disposed on at least one side of the flexible plate, wherein the plurality of cavities have one or more arbitrary cavity shapes, wherein the plurality of flexible puzzle pieces have one or more arbitrary piece shapes, wherein a thickness of the plurality of flexible puzzle pieces is equal to or greater than a depth of the plurality of cavities, wherein at least one of the one or more arbitrary piece shapes substantially matches a shape of at least one of the one or more arbitrary cavity shapes, and wherein at least one of the plurality of flexible puzzle pieces is removably insertable in at least one of the plurality of cavities.

18. The plurality of flexible puzzle pieces of claim 17, wherein at least one of the plurality of flexible puzzle pieces comprises at least one of an embossing, a debossing, and an imprint.

19. The plurality of flexible puzzle pieces of claim 17, wherein the piece shapes comprise at least one of:
(i) shapes of letters of alphabet;
(ii) shapes of foreign language special characters;
(iii) shapes of numbers;
(iv) geometric shapes;
(v) shapes of persons; and
(vi) shapes of animals.

20. A method of engaging a child, comprising:
(a) providing a flexible plate comprising a plurality of cavities disposed on at least one side of the flexible plate, wherein the plurality of cavities have one or more arbitrary cavity shapes;
(b) providing a wire embedded inside the flexible plate and disposed along a perimeter of the flexible plate, wherein the wire is operable to partially resist the flexing of the flexible plate; and
(c) providing a plurality of flexible puzzle pieces, wherein the plurality of flexible puzzle pieces have one or more arbitrary piece shapes;
wherein a thickness of the plurality of flexible puzzle pieces is equal to or greater than a depth of the plurality of cavities, wherein at least one of the one or more arbitrary piece shapes substantially matches a shape of at least one of the one or more arbitrary cavity shapes, and wherein at least one of the plurality of flexible puzzle pieces is removably insertable in at least one of the plurality of cavities.
